(19) United States
(12) Patent Application Publication
(10) Pub. No.: US 2015/0309219 A1
(43) Pub. Date: Oct. 29, 2015

(54) UV Reflective and Cooling System for Clothing

(71) Applicant: Reel Wings Decoy Co. Inc., Fargo, ND (US)

(72) Inventor: Scott A. Butz, Fargo, ND (US)

(73) Assignee: Reel Wings Decoy Co. Inc.

(21) Appl. No.: 14/694,474

(22) Filed: Apr. 23, 2015

Related U.S. Application Data
(60) Provisional application No. 61/983,280, filed on Apr. 23, 2014.

(51) Int. Cl. G02B 5/08; A41D 31/00

(52) U.S. Cl. CPC G02B 5/0891; A41D 31/0033

(57) ABSTRACT

A UV reflective and cooling system for clothing for effectively reflecting UV light to provide a cooler temperature for a person. The UV reflective and cooling system for clothing generally includes a clothing item having UV light reflective properties incorporated to reflect UV light away from the person wearing the clothing. The clothing includes at least one increased reflective zone to reflect an increased amount of UV light away from the user. For a shirt, the increased reflective zone is within the upper portion of the shirt which protects the body of the user that would normally experience the most UV light exposure.

### CROSS REFERENCE TO RELATED APPLICATIONS

I hereby claim benefit under Title 35, United States Code, Section 119(e) of U.S. provisional patent application Ser. No. 61/983,280 filed Apr. 23, 2014. The 61/983,280 application is currently pending. The 61/983,280 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to clothing and more specifically it relates to a UV reflective and cooling system for effectively reflecting UV light to provide a cooler temperature for a person.

2. Description of the Related Art

Any discussion of the related art throughout the specification should in no way be considered as an admission that such related art is widely known or forms part of common general knowledge in the field.

Sunlight is comprised of visible light, ultraviolet (UV) light and infrared (IF) light. Ultraviolet light is damaging to the skin of humans and also generates heat. Infrared light is believed to also be damaging to the skin of humans and also generates heat. When humans are exposed to the sun, they are exposed to health risks such as, but not limited to, sunburn and heat stroke.

The visible light spectrum for humans extends only between 400 nm to 700 nm. The light spectrum above 700 nm to 1 mm is mostly not visible to humans and is comprised of infrared light (a.k.a. infrared radiation). The light spectrum below 400 nm is also not visible to humans and is comprised of ultraviolet light (a.k.a. ultraviolet radiation). Ultraviolet (UV) light is usually identified by three general regions: UVA (310 nm to 400 nm), UVB (290 nm to 310 nm) and UVC (light below 290 nm).

UVA radiation from the sun is not absorbed by the atmosphere and passes through the atmosphere to the surface of the earth. UVA radiation is harmful to humans when they are exposed to UVA radiation for extended periods of time (e.g. sunburns, skin cancer, premature aging of the skin). UVB radiation is partially absorbed by the atmosphere but some UVB radiation still reaches the surface of the earth. UVB radiation is also harmful to humans similar to UVA radiation. UVC radiation is substantially absorbed by the atmosphere without reaching the surface of the earth. It is therefore important for individuals to protect themselves from UVA radiation to reduce the chances of potentially adverse health effects.

One way that humans protect themselves from UVA radiation is to use sunscreen (a.k.a. sunblock, suntan lotion). One type of sunscreen absorbs UV light and another type of sunscreen reflects UV light to protect the skin of the user from being damaged by the UV light.

Unfortunately, clothing is comprised of a natural or artificial fibers that are dyed a preferred color which typically absorb ultraviolet light (particularly darker colors) making the clothing hot to wear in the sunlight. While conventional clothing does absorb a portion of sunlight including ultraviolet light, conventional clothing does not reflect a significant portion of the ultraviolet light and by absorbing the ultraviolet light the temperature of the clothing is increased when exposed to sunlight making the clothing uncomfortable for the user to wear for extended periods of time.

Some commercially available products (e.g. spray on liquids) that absorb ultraviolet light are sold to hunters because they reduce the reflection of ultraviolet light that is viewable to waterfowl. In addition, clothing will sometimes have water proofing chemicals applied to the exterior surface of the clothing to waterproof the clothing. Some water proofing chemicals applied to clothing block ultraviolet light but this is incidental and not directed at blocking UV light from contacting the individual.

Because of the inherent problems with the related art, there is a need for a new and improved UV reflective and cooling system for effectively reflecting UV light to provide a cooler temperature for a person.

### BRIEF SUMMARY OF THE INVENTION

The invention generally relates to clothing which includes a clothing item having UV light reflective properties incorporated to reflect UV light away from the person wearing the clothing. The clothing includes at least one increased reflective zone to reflect an increased amount of UV light away from the user. For a shirt, the increased reflective zone is within the upper portion of the shirt which protects the body of the user that would normally experience the most UV light exposure.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front view of a shirt with the UV reflective properties throughout the entire shirt.

FIG. 2 is a rear view of the shirt.

FIG. 3 is a top view of the shirt.

FIG. 4 is a front view of an alternative embodiment for the shirt having a higher reflective area on the upper portion of the shirt to increase the amount of UV light reflected.

FIG. 5 is a rear view of the alternative embodiment of the shirt.

FIG. 6 is a top view of the alternative embodiment of the shirt.

FIG. 7 is a right side view of the alternative embodiment of the shirt.

FIG. 8 is a front view of a pair of pants having the UV reflective properties throughout the entire pair of pants.

FIG. 9 is a rear view of the pants.

FIG. 10 is an upper perspective view illustrating the fabric material reflecting the UV light.

### DETAILED DESCRIPTION OF THE INVENTION

### A. Overview

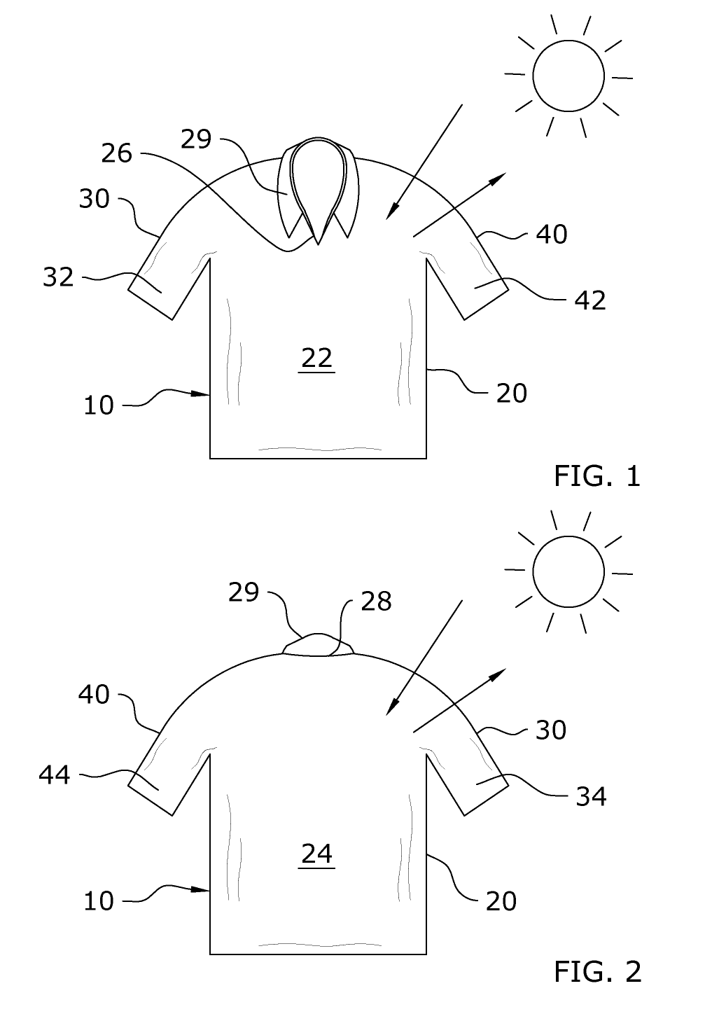

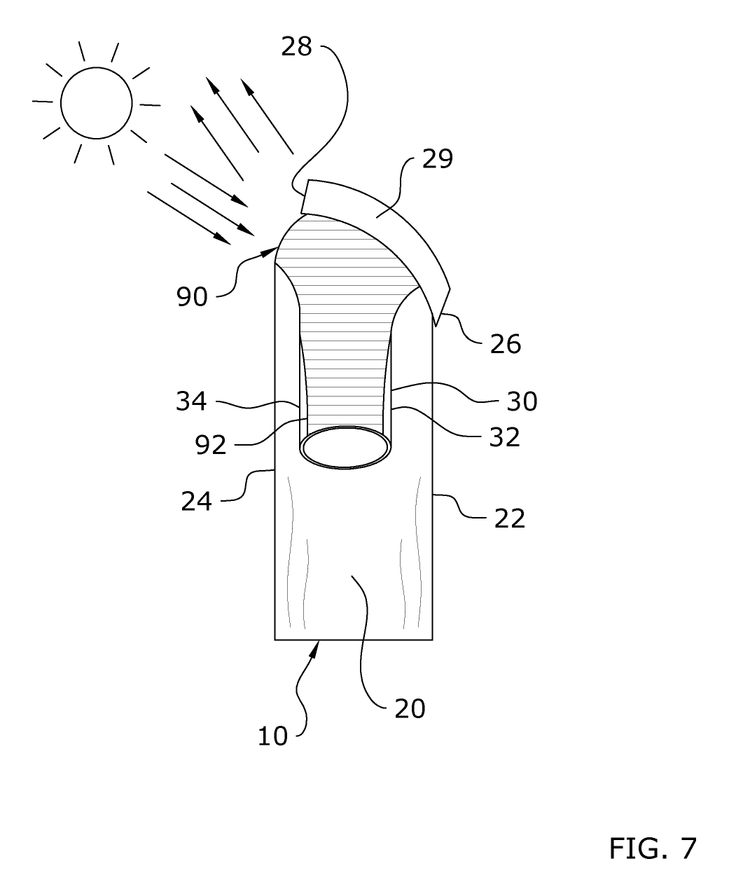

Turning now descriptively to the drawings, in which similar reference characters denote similar elements throughout the several views, FIGS. 1 through 9 illustrate a UV reflective and cooling system for clothing, which comprises a clothing item having UV light reflective properties incorporated to reflect UV light away from the person wearing the clothing. The clothing includes at least one increased reflective zone to reflect an increased amount of UV light away from the user. For a shirt 10, the increased reflective zone is within the upper portion of the shirt 10 which protects the body of the user that would normally experience the most UV light exposure.

The present invention may be utilized upon various types of clothing such as, but not limited to, shirts, short-sleeved shirts, long-sleeved shirts, Henley shirt, polo shirt 10, tank tops, T-shirts, sweaters, vests, overalls, pants, jeans, shorts, swim trunks, bathing suits, hats, baseball hats, dresses, skirts, blouses, socks, shoes, gloves, face masks, jackets, coats and any other clothing item that may be worn by a human. The ultraviolet light reflective material may be applied to the fabric material 12 of the clothing in various manners such as, but not limited to, dyeing, printing on the exterior surface of the fabric material 12, manual printing, screen printing, digital printing and the like.

The term “fabric material” as used herein refers to any natural fiber (e.g. cotton, wool, silk, linen, flax, ramie), synthetic fiber (e.g. nylon, polyester, acrylic, lycra) or semi-synthetic fiber (e.g. rayon, modal) commonly used to construct clothing including all textiles and cloth. The fabric material 12 may be formed using various types of well-known methods such as, but not limited to, weaving, knitting, crocheting, knotting and pressing fibers together (e.g. felt).

### B. Shirt with UV Light Reflective Properties

FIGS. 1 through 7 illustrate an ultraviolet light reflective shirt 10 that reflects ultraviolet light away from the fabric material 12 of the shirt 10 and away from the skin of the user. The shirt 10 may be comprised of any conventional type of shirt 10 capable of being worn by a human.

As illustrated in FIGS. 1 through 7, the shirt 10 has a torso portion 20, a right sleeve extending from a right side of an upper torso portion 20 of the torso portion 20 and a left sleeve extending from a left side of the upper torso portion 20 of the torso portion 20. FIGS. 1 through 7 illustrate a T-shirt 10 with short sleeves, but it can be appreciated that the shirt 10 may have long sleeves that extend to near the hands of the user.

The torso portion 20 includes a front torso surface 22 and a rear torso surface 24 opposite of the front torso surface 22 as illustrated in FIGS. 1, 2, 4 and 5 of the drawings. The front torso surface 22 and the rear torso surface 24 extend upwardly from a bottom edge of the shirt 10 to the upper portion of the shirt 10 where the front torso surface 22 and the rear torso surface 24 meet at the top of the upper portion. The connection of the front torso surface 22 and the rear torso surface 24 at the top of the upper portion is along a line that extends from the right side to the left side of the shirt 10.

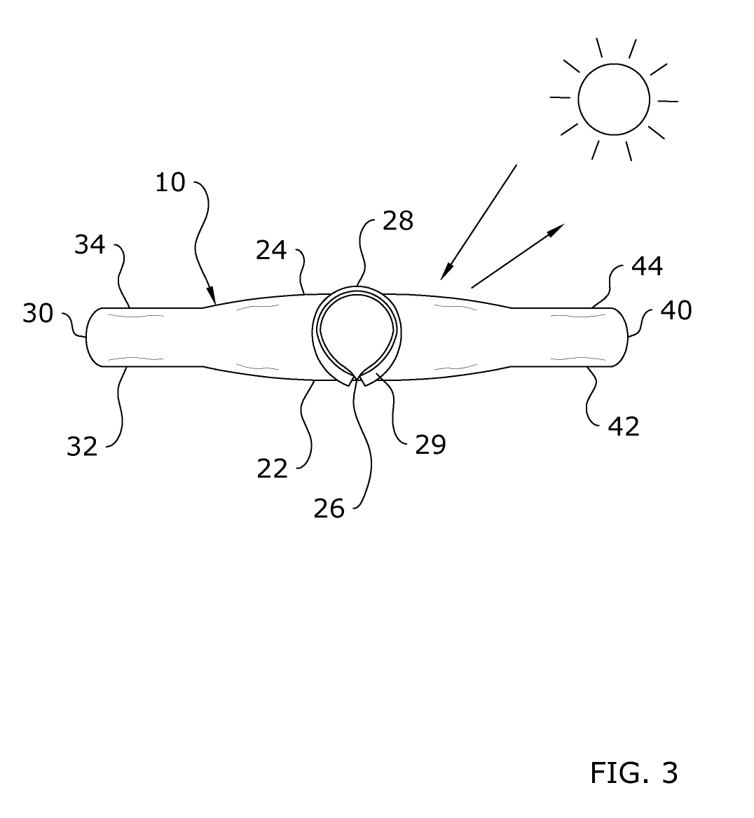

FIG. 3 illustrates the upper portion of the shirt 10 showing the upper portion of the torso portion 20, the right sleeve portion 30 and the left sleeve portion 40. The upper portion of the shirt 10 may extend downwardly below the rear neck portion 28 and the front neck portion 26 of the shirt 10. The upper portion of the shirt 10 is preferably comprised of a portion of the shirt 10 that typically faces upwardly when worn by the user which typically experiences the most significant exposure to ultraviolet light such as the shoulder portion of the shirt 10. A neck opening extends within and through the upper portion of the torso portion 20 as illustrated in FIGS. 1, 3, 4 and 6 of the drawings. The shirt 10 may include a collar 29 that surrounds at least a portion of the neck opening as illustrated in FIGS. 1 through 7 of the drawings.

The right sleeve includes a front right surface 32 and a rear right surface 34 which correspond to the front torso surface 22 and the rear torso surface 24 as illustrated in FIGS. 1 through 7. The left sleeve includes a front left surface 42 and a rear left surface 44 which correspond to the front torso surface 22 and the rear torso surface 24 as illustrated in FIGS. 1 through 7 of the drawings.

The shirt 10 includes one or more ultraviolet light reflective zones 90 that reflect a substantial portion (i.e. over 50%) of ultraviolet light received from sunlight to prevent the ultraviolet light from contacting the skin of a user beneath the shirt 10 and to reduce the amount of heat received by the user from sunlight. It is further preferable that the ultraviolet light reflective zone 90 reflects over 80% of the ultraviolet light.

The ultraviolet light reflective zone 90 is comprised of a fabric material 12 that reflects at least ultraviolet light. The ultraviolet light reflective zone 90 is further preferably comprised of a fabric material 12 that reflects both ultraviolet light and infrared light. The ultraviolet reflective zone is preferably comprised of a fabric material 12 that does not reflect a significant portion of visible light.

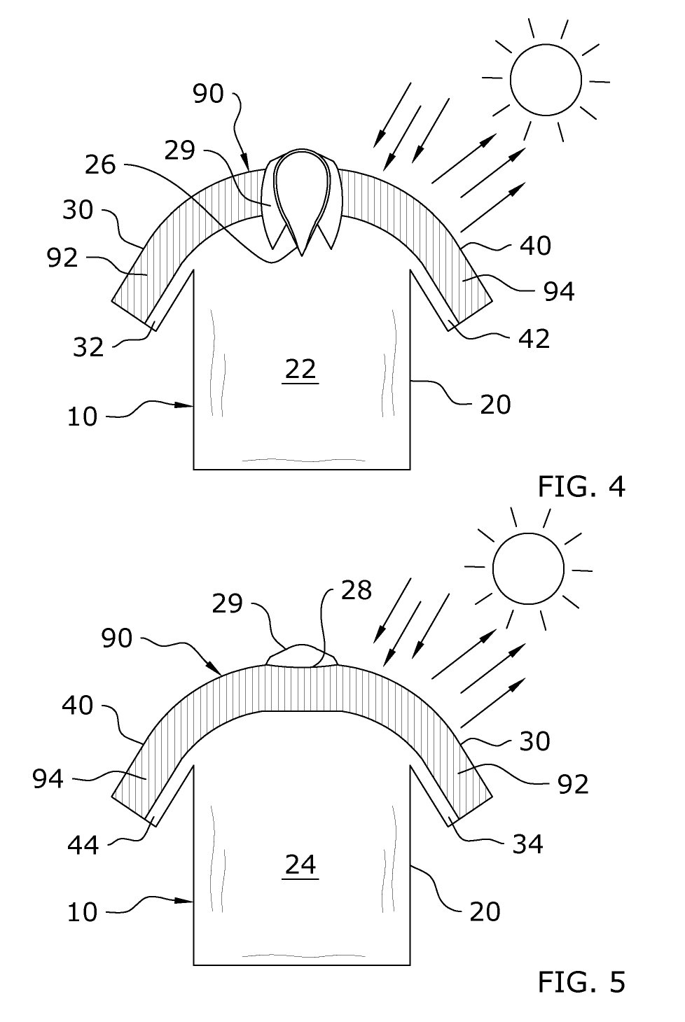

The ultraviolet reflective zone may be comprised of the entire or a majority of the shirt 10 as illustrated in FIGS. 1 through 3 of the drawings. However, the ultraviolet light reflective zone 90 is preferably comprised of an upper portion of the front torso surface 22, an upper portion of the rear torso surface 24, an upper portion of the front right surface 32, an upper portion of the front left surface 42, an upper portion of the rear right surface 34 and an upper portion of the rear left surface 44 as illustrated in FIGS. 4 through 6 of the drawings. The zone 90 may be the only portion of the shirt 10 that is treated with the ultraviolet light reflective material. Alternatively, the entire shirt 10 may be treated with the ultraviolet light reflective material with the zone 90 having an increased amount of ultraviolet light reflective material to increase the ultraviolet light reflective properties for the portion of the shirt 10 in the zone 90 as compared to the remainder of the shirt 10.

The at least one ultraviolet light reflective zone 90 has preferably the same visual appearance to humans as a remaining portion of the shirt 10. Hence, while the shading pattern in FIGS. 4 through 6 illustrate the ultraviolet light reflective zone 90 (or an increased ultraviolet light reflective area compared to the remainder of the shirt 10), the shading pattern is used for illustrative purposes only to indicate the location of the ultraviolet light reflective zone 90 in the embodiment shown therein and is not intended to require a different visual appearance compared to the remainder of the shirt 10. For example, the shirt 10 may have the visible color red with or without a pattern without the ultraviolet light reflective zone 90 changing the appearance of the shirt 10. Alternatively, the ultraviolet light reflective zone 90 90 may have a different visual appearance from the remainder of the shirt 10 (e.g. a different color, a different material type, or a different fabric material 12 compared to the remainder of the shirt 10). The ultraviolet light reflective zone 90 is preferably not visually perceivable to humans but may be visually perceivable in certain applications.

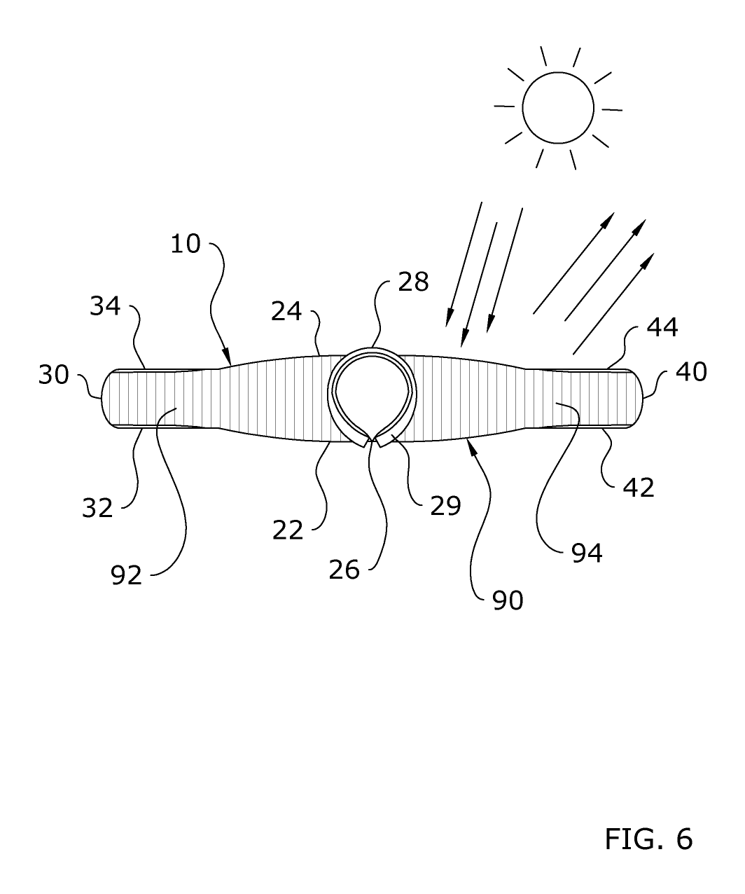

The ultraviolet light reflective zone 90 is preferably within the upper portion of the shirt 10 as discussed previously. It is preferable that the at least one ultraviolet light reflective zone 90 does not extend below a front neck portion 26 of the shirt 10 as illustrated in FIG. 4 of the drawings. The ultraviolet light reflective zone 90 preferably extends below a rear neck portion 28 of the shirt 10 as illustrated in FIG. 5. The collar 29 is preferably part of the at least one ultraviolet light reflective zone 90 but alternatively may not be part thereof.

The ultraviolet light reflective zone 90 is preferably comprised of a right reflective zone 92 on an upper surface of the shirt 10 and a left reflective zone 94 on the upper surface of the shirt 10 as illustrated in FIGS. 4 through 6 of the drawings. The left reflective zone 94 and the right reflective zone 92 are preferably separated at the front neck portion 26 and connected below the rear neck portions 28 as illustrated in FIGS. 4 and 5 of the drawings.

The ultraviolet light reflective zone 90 may be located in one or more different locations within the shirt 10. It is preferable that the ultraviolet light reflective zone 90 is located within an upper surface of the shirt 10. It is preferable that the ultraviolet light reflective zone 90 is located within the upper torso portion 20 of the shirt 10 which experiences a significant amount of the sunlight when the user is outdoors. The ultraviolet light reflective zone 90 may also be located within the rear torso surface 24 and/or the front torso surface 22. It is preferable that the ultraviolet light reflective zone 90 is located within at least the upper torso portion 20 of the rear torso surface 24. It is further preferable that the ultraviolet light reflective zone 90 is located within at least the upper torso portion 20 of the rear torso surface 24 and the front torso surface 22 as illustrated in FIGS. 4 through 6 of the drawings.

It is further preferable that the ultraviolet light reflective zone 90 is located within at least the upper torso portion 20 of the rear torso surface 24 and the front torso surface 22 along with the upper portions of the right sleeve portion 30 and the left sleeve portion 40 as further illustrated in FIGS. 4 through 6 of the drawings. It is preferable that a significantly reduced amount of or no additional ultraviolet light reflective material is used within the portion of the shirt 10 below the ultraviolet light reflective zone 90.

The ultraviolet light reflective material used for the ultraviolet light reflective zone 90 may be comprised of any fabric material 12 or fabric material 12 combined with an ultraviolet light reflective material that reflects a significant portion of the ultraviolet light (and preferably infrared light) received from sunlight. The ultraviolet light reflective material may be embedded within or printed on the fabric material 12 of the shirt 10. For example, the ultraviolet light reflective material may be comprised of a dye with UV reflective properties.

### C. Pants with UV Light Reflective Properties

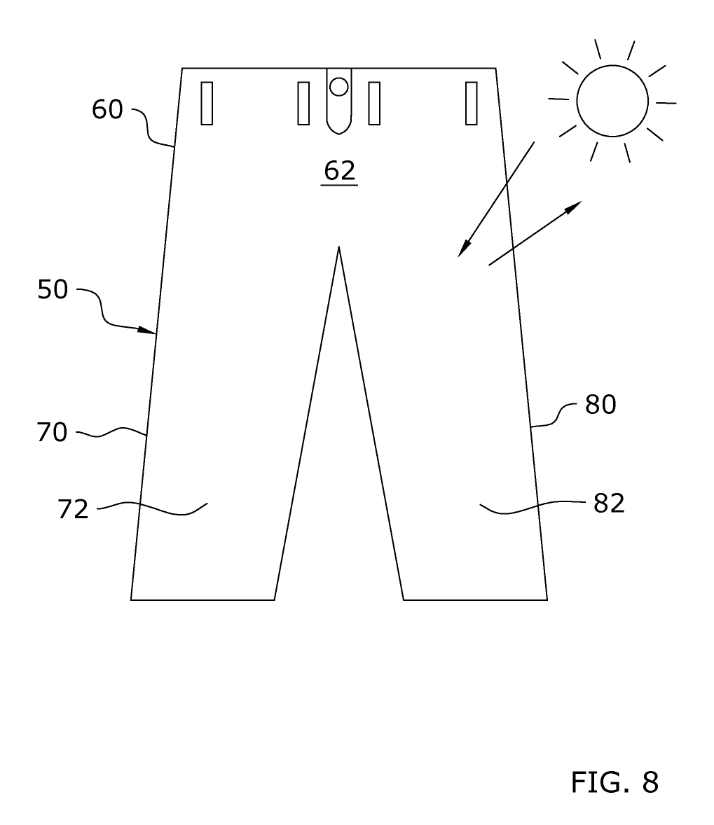

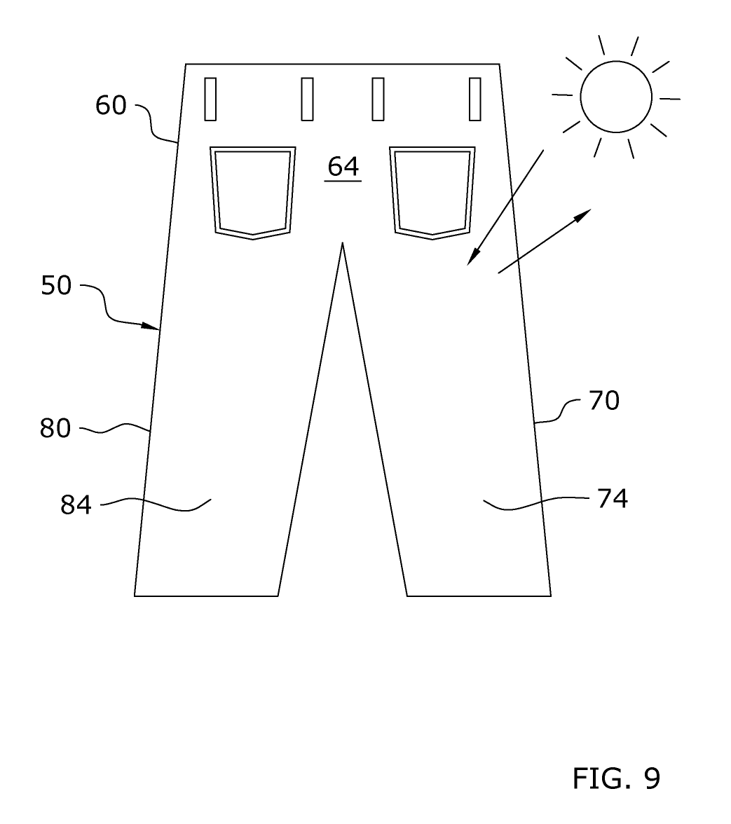

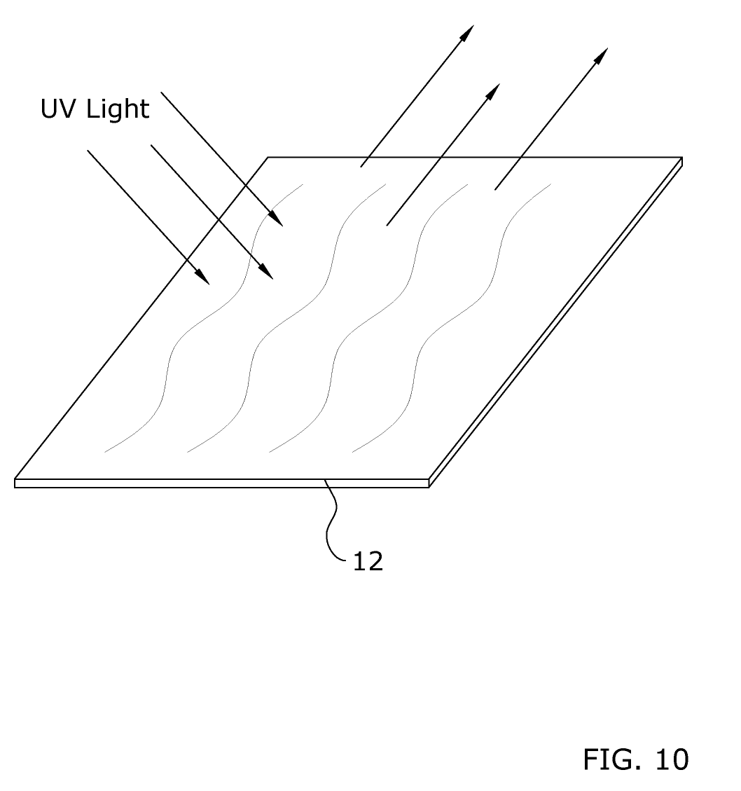

FIGS. 8 through 9 illustrate an ultraviolet light reflective pair of pants 50 where the ultraviolet light reflective material is used throughout the entire pair of pants 50. The pants 50 are comprised of a waist portion 60 with a front waist 62 and a rear waist 64. The pants 50 further include a right leg 70 with a front right leg 72 and a rear right leg 74. The pants 50 further include a left leg 80 with a front left leg 82 and a rear left leg 84. As can be appreciated, different zones may have an increased amount of UV reflective material such as the upper front thigh portions, the knee portions and the upper rear portion. The present invention may be utilized with various other types of clothing.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An ultraviolet light reflective shirt, comprising:
a shirt having a torso portion, a right sleeve extending from a right side of an upper torso portion of said torso portion and a left sleeve extending from a left side of said upper torso portion of said torso portion;
wherein said torso portion includes a front torso surface, a rear torso surface and a neck opening within said upper portion;
wherein said right sleeve includes a front right surface and a rear right surface;
wherein said left sleeve includes a front left surface and a rear left surface;
wherein said shirt includes at least one ultraviolet light reflective zone, wherein said at least one ultraviolet light reflective zone reflects a substantial portion of ultraviolet light received from sunlight to prevent the ultraviolet light from contacting the skin of a user beneath said shirt and to reduce the amount of heat received by the user from sunlight.

2. The ultraviolet light reflective shirt of claim 1, wherein said at least one ultraviolet light reflective zone has the same visual appearance to humans as a remaining portion of said shirt.

3. The ultraviolet light reflective shirt of claim 1, wherein said at least one ultraviolet light reflective zone is not visually perceivable to humans.

4. The ultraviolet light reflective shirt of claim 1, wherein said at least one ultraviolet light reflective zone is comprised of said front torso surface, said rear torso surface, said front right surface, said front left surface, said rear right surface and said rear left surface.

5. The ultraviolet light reflective shirt of claim 1, wherein said shirt includes a collar surrounding at least a portion of said neck opening, wherein said collar is part of said at least one ultraviolet light reflective zone.

6. The ultraviolet light reflective shirt of claim 1, wherein said at least one ultraviolet light reflective zone is located within said upper torso portion of said shirt.

7. The ultraviolet light reflective shirt of claim 1, wherein said at least one ultraviolet light reflective zone is located within said rear torso surface.

8. The ultraviolet light reflective shirt of claim 7, wherein said at least one ultraviolet light reflective zone is located within said upper torso portion of said shirt.

9. The ultraviolet light reflective shirt of claim 1, wherein said at least one ultraviolet light reflective zone is located within said rear torso surface and said front torso surface.

10. The ultraviolet light reflective shirt of claim 9, wherein said at least one ultraviolet light reflective zone is located within said upper torso portion of said shirt.

11. The ultraviolet light reflective shirt of claim 10, wherein said at least one ultraviolet light reflective zone does not extend below a front neck portion of said shirt.

12. The ultraviolet light reflective shirt of claim 11, wherein said at least one ultraviolet light reflective zone extends below a rear neck portion of said shirt.

13. The ultraviolet light reflective shirt of claim 1, wherein said at least one ultraviolet light reflective zone is located within an upper surface of said shirt.

14. The ultraviolet light reflective shirt of claim 9, wherein said at least one ultraviolet light reflective zone is located within a portion of said front torso surface, a portion of said rear torso surface, a portion of said front right surface, a portion of said front left surface, a portion of said rear right surface and a portion of said rear left surface.

15. The ultraviolet light reflective shirt of claim 1, wherein said at least one ultraviolet light reflective zone is comprised of an ultraviolet light reflective material applied to said at least one ultraviolet light reflective zone.

16. The ultraviolet light reflective shirt of claim 15, wherein said ultraviolet light reflective material is comprised of a dye printed on a fabric material of said shirt.

17. The ultraviolet light reflective shirt of claim 15, wherein said ultraviolet light reflective material is comprised of a dye printed on a fabric material of said shirt.

18. The ultraviolet light reflective shirt of claim 15, wherein said ultraviolet light reflective material is embedded within a fabric material of said shirt.

19. The ultraviolet light reflective shirt of claim 1, wherein said at least one ultraviolet light reflective zone is comprised of a right reflective zone on an upper surface of said shirt and a left reflective zone on said upper surface of said shirt.

20. An ultraviolet light reflective shirt, comprising:
a shirt having a torso portion, a right sleeve extending from a right side of an upper torso portion of said torso portion and a left sleeve extending from a left side of said upper torso portion of said torso portion;
wherein said torso portion includes a front torso surface, a rear torso surface and a neck opening within said upper portion;
wherein said right sleeve includes a front right surface and a rear right surface;
wherein said left sleeve includes a front left surface and a rear left surface;
wherein said shirt includes at least one ultraviolet light reflective zone, wherein said at least one ultraviolet light reflective zone reflects a substantial portion of ultraviolet light received from sunlight to prevent the ultraviolet light from contacting the skin of a user beneath said shirt and to reduce the amount of heat received by the user from sunlight;
wherein said at least one ultraviolet light reflective zone is comprised of an upper portion of said front torso surface, an upper portion of said rear torso surface, an upper portion of said front right surface, an upper portion of said front left surface, an upper portion of said rear right surface and an upper portion of said rear left surface;
wherein said at least one ultraviolet light reflective zone does not extend below a front neck portion of said shirt.
